(19) United States
(12) Patent Application Publication
(10) Pub. No.: US 2025/0198768 A1
(43) Pub. Date: Jun. 19, 2025

(54) INFORMATION PROCESSING DEVICE

(71) Applicant: TOYOTA JIDOSHA KABUSHIKI KAISHA, Toyota-shi (JP)

(72) Inventor: Yu NAGATA, Tokyo (JP)

(73) Assignee: TOYOTA JIDOSHA KABUSHIKI KAISHA, Toyota-shi (JP)

(21) Appl. No.: 18/889,846

(22) Filed: Sep. 19, 2024

(30) Foreign Application Priority Data
Dec. 15, 2023 (JP) 2023-212128

(51) Int. Cl. G01C 21/34; G01C 21/36

(52) U.S. Cl. CPC G01C 21/3415; G01C 21/3617

(57) ABSTRACT

The control unit of the information processing device acquires the acceptance rate of the user of the vehicle with respect to the proposal of the bypass in the past when there is a bypass recommendation section in which the bypass is recommended on the route of the vehicle. Then, the control unit of the information processing device outputs the proposal information for proposing to bypass the bypass recommendation section in accordance with the acceptance rate.

### CROSS-REFERENCE TO RELATED APPLICATION

This application claims priority to Japanese Patent Application No. 2023-212128 filed on Dec. 15, 2023, incorporated herein by reference in its entirety.

### BACKGROUND

### 1. Technical Field

The present disclosure relates to an information processing device.

### 2. Description of Related Art

Japanese Unexamined Patent Application Publication No. 2022-179906 (JP 2022-179906 A) discloses a navigation device. The navigation device disclosed in Japanese Unexamined Patent Application Publication No. 2022-179906 detects an entry prohibition node which is a node for which entry prohibition traffic restriction information has been set. The navigation device detects a plurality of road links of a predetermined section where it is possible to estimate that traveling has been restricted, the road links being connected in cascade from the detected entry prohibition node. The navigation device sets travel restriction information on route search for the plurality of detected road links. Then, the navigation device searches for a route using, as restriction target sections, the plurality of road links for which the travel restriction information has been set.

### SUMMARY

An object of the present disclosure is to propose bypassing so that a user does not feel bothered.

An information processing device according to the present disclosure includes a control unit that is configured to execute:
acquiring an acceptance rate of a user of a vehicle in response to past bypass proposals when there is a bypass recommendation section in which bypassing is recommended on a route of the vehicle; and
outputting proposal information for proposing to bypass the bypass recommendation section in accordance with the acceptance rate.

According to the present disclosure, it is possible to propose bypassing so that a user does not feel bothered.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a proposed system;

FIG. 2 is a block diagram schematically illustrating an example of a functional configuration of a server;

FIG. 3 is a diagram illustrating an example of a table configuration of road information held in a road information database;

FIG. 4 is a diagram illustrating an example of a table configuration of history information held in a history information database;

FIG. 5 is a flow chart of a first process; and

FIG. 6 is a flowchart of a second process.

### DETAILED DESCRIPTION OF EMBODIMENTS

In the case where there is a bypass recommendation section in which bypassing is recommended on a route on which a vehicle travels, it is assumed that bypassing of the bypass recommendation section is proposed to a user of the vehicle. At this time, in a case where the user of the vehicle is a user who does not need to propose bypassing, there is a case where the user feels troublesomeness with respect to the proposal of the bypassing. Therefore, the information processing device according to the present disclosure solves such a problem.

The control unit of the information processing device according to the present disclosure acquires an acceptance rate (hereinafter, may be simply referred to as an “acceptance rate”) of a user with respect to a proposal of bypassing in the past when a bypassing recommendation section exists on a route of a vehicle. Thus, the control unit of the information processing device can grasp the necessity of proposing bypassing to the user. At this time, when the acceptance rate is high, it is assumed that the user needs to propose a bypass as compared with the case where the acceptance rate is low. Therefore, the control unit outputs the proposal information for proposing to bypass the bypass recommendation section in accordance with the acceptance rate.

As described above, the information processing device outputs the proposal information according to the acceptance rate. Accordingly, it is possible to propose bypassing of the bypass recommendation section according to the necessity of the bypass proposal which can be assumed from the acceptance rate. As a result, it is possible to make a bypassing proposal so that the user does not feel troublesomeness.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### Embodiment

### System Overview

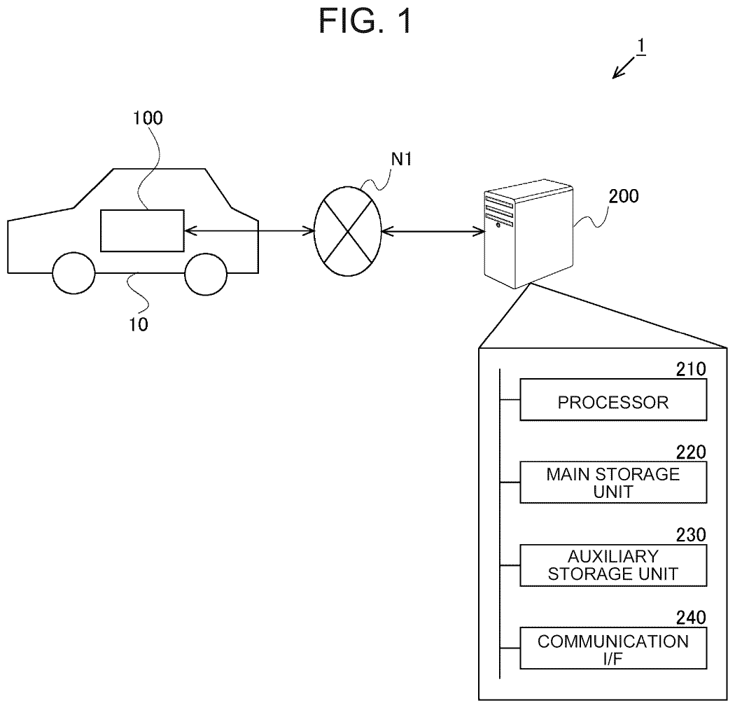

The proposal system 1 according to the present embodiment will be described with reference to FIG. 1. FIG. 1 is a diagram illustrating a schematic configuration of a proposal system 1. The proposal system 1 includes an in-vehicle device 100 and a server 200. In the proposal system 1, the in-vehicle device 100 and the server 200 are connected to each other by a network N1. The network N1 may be, for example, a worldwide public communication network such as Internet or the like, and a wide area network (WAN) or a telecommunications network such as a cellular network.

### In-Vehicle Device

The in-vehicle device 100 is a device mounted on the vehicle 10. The in-vehicle device 100 provides various kinds of information to the user of the vehicle 10. The in-vehicle device 100 is, for example, a car navigation system. A user of the vehicle 10 inputs a destination to the in-vehicle device 100. The in-vehicle device 100 transmits destination information indicating the present position and the destination of the vehicle 10 to the server 200 via the network N1.

The in-vehicle device 100 receives the route data via the network N1. The route information is information including a scheduled traveling route of the vehicle 10. Upon receiving the route information, the in-vehicle device 100 outputs the route information to the user of the vehicle 10 (display on a display, sound output, and the like). In addition, the in-vehicle device 100 receives proposal information from the server 200 via the network N1. The proposal information is information for proposing to bypass a section on a scheduled traveling route. Upon receiving the proposal information, the in-vehicle device 100 outputs (displays, etc.) the proposal information to the user of the vehicle 10.

### Server

The server 200 is a server device that manages the travel of the vehicle. The server 200 receives the destination information from the in-vehicle device 100 via the network N1. The server 200 generates a scheduled traveling route of the vehicle 10 in accordance with the destination information. At this time, there may be a section in which bypassing is recommended (hereinafter, sometimes referred to as a “bypass recommendation section”) on a scheduled traveling route of the vehicle 10. The reason why the bypassing is recommended is, for example, the stoppage of the passage of part or all of the section, flooding, congestion, snow accumulation, or the like. In such a case, it is assumed that the server 200 proposes to the user of the vehicle 10 to bypass the bypass recommendation section. Specifically, the server 200 proposes to bypass the bypass recommendation section by transmitting the proposal information to the in-vehicle device 100.

At this time, some users may not need to propose bypassing. In this case, the user may feel troublesome by making an unnecessary bypass proposal to the user. Therefore, the acceptance rate of the user of the vehicle 10 (hereinafter, sometimes simply referred to as “acceptance rate”) for the proposal of the bypass in the past is acquired.

At this time, when the acceptance rate is high, it is assumed that the user needs to propose a bypass as compared with the case where the acceptance rate is low. On the other hand, when the acceptance rate is low, it is assumed that the user of the vehicle 10 does not need to propose a bypass as compared with the case where the acceptance rate is high. As described above, the server 200 can grasp the necessity of proposing bypassing to the user of the vehicle 10 by acquiring the acceptance rate. Therefore, if unnecessary bypassing is proposed to the user when the acceptance rate is lower than in the case where the acceptance rate is high, it is assumed that the user feels troublesome. Therefore, the server 200 outputs the proposal information to the in-vehicle device 100 in accordance with the acceptance rate.

In the present embodiment, when the acceptance rate is equal to or greater than the threshold value, the server 200 outputs the proposal information to the in-vehicle device 100 via the network N1. Further, in the present embodiment, the server 200 may not output the proposal information when the acceptance rate is less than the threshold value. The output of the proposal information by the server 200 will be described in detail later.

The server 200 includes a computer having a processor 210, a main storage unit 220, an auxiliary storage unit 230, and a communication interface (communication I/F) 240. The processor 210 is, for example, a central processing unit (CPU) or a digital signal processor (DSP). The main storage unit 220 is, for example, a random access memory (RAM). The auxiliary storage unit 230 is, for example, a read only memory (ROM). The auxiliary storage unit 230 is, for example, a hard disk drive (HDD) or a disc recording medium such as a CD-ROM, a DVD disc, or a Blu-ray disc. The auxiliary storage unit 230 may be a removable medium (a portable storage medium). Examples of the removable medium include a USB memory or an SD card. The communication I/F 240 is, for example, a local area network (LAN) interface board or wireless communication circuitry for wireless communication.

In the server 200, an operating system (OS), various programs, various information tables, and the like are stored in the auxiliary storage unit 230. Further, in the server 200, the processor 210 loads the program stored in the auxiliary storage unit 230 into the main storage unit 220 and executes the program, thereby realizing various functions as described later. However, some or all of the functions of the server 200 may be implemented by hardware circuitry such as ASIC or FPGA. Note that the server 200 does not necessarily have to be realized by a single physical configuration, and may be constituted by a plurality of computers that cooperate with each other. Similarly to the server 200, the in-vehicle device 100 includes a computer.

### Functional Configuration

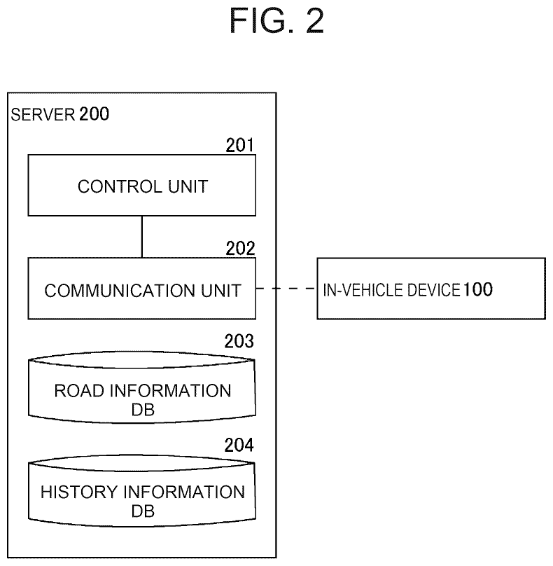

Next, the proposal system 1 is configured. The functional configuration of the server 200 will be described with reference to FIG. 2 to FIG. 4. FIG. 2 is a block diagram schematically illustrating an example of a functional configuration of the server 200. The server 200 is configured to include a control unit 201, a communication unit 202, a road information database 203 (road information DB 203), and a history information database 204 (history information DB 204).

The control unit 201 has a function of performing arithmetic processing for controlling the server 200. The control unit 201 can be realized by the processor 210 in the server 200. The communication unit 202 has a function of connecting the server 200 to a network N1. The communication unit 202 can be realized by a communication I/F 240 in the server 200.

The control unit 201 receives destination information from the in-vehicle device 100 via the communication unit 202. The control unit 201 refers to the current position and the destination of the vehicle 10 included in the destination information, and determines a scheduled traveling route of the vehicle 10. Here, the control unit 201 determines, for example, a route having the shortest travel distance among a plurality of routes from the current position of the vehicle 10 to the destination as a travel scheduled route. The control unit 201 transmits the determined travel schedule route to the in-vehicle device 100 via the communication unit 202.

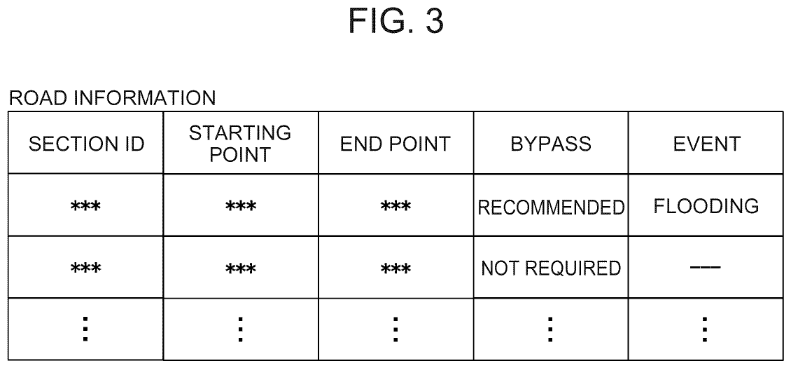

The road information DB 203 has a function of holding road information. The road information DB 203 can be realized by the auxiliary storage unit 230 in the server 200. FIG. 3 is a diagram illustrating an exemplary table configuration of road information held in the road information DB 203. The road information is information indicating whether bypassing is recommended in each section. As illustrated in FIG. 3, the roadway data includes a section ID field, a start field, an end field, a bypass field, and an event field.

In the section ID field, an identifier (section ID) for identifying a road section is stored. The start point field stores information indicating a start point of a section of the corresponding section ID. In the end point field, information indicating an end point of a section of the corresponding section ID is stored. Here, the section ID is, for example, an identifier for identifying a road link. In this case, the starting field contains an identifier that identifies the node of the starting point of the road-link of the corresponding section ID. In addition, the end-point field stores an identifier for identifying a node of the end-point of the road-link in the corresponding section ID.

In the Bypass field, information indicating whether the bypass of the section ID the corresponding section is recommended is stored. If bypassing of the corresponding section ID is recommended, the bypass field is stored with “Recommended”. When the bypassing of the section of the corresponding section ID is not recommended (unnecessary), the bypass field is stored with “unnecessary”.

In the event field, when a “recommendation” is entered in the corresponding bypass field, information indicating the event causing the recommended bypassing of the section of the corresponding section ID is stored. Here, in the event field, information indicating a stop of passage, flood, traffic jam, snow accumulation, or the like of a part or all of the section is stored. In the event field shown in FIG. 3, information “flooding” is stored in the event field corresponding to the section in which bypassing is recommended. In the event field shown in FIG. 3, information “ - - - ” is stored in the event field corresponding to the section in which no bypassing is recommended.

The control unit 201 updates the road data by acquiring, in real time, the presence or absence of a recommendation for bypassing in the section ID from other servers or the like that manage the road. In addition, the control unit 201 may analyze an image of a state of a section included in a moving image captured by a camera mounted on a plurality of vehicles traveling, and determine whether to recommend bypassing. In this case, the control unit 201 determines whether flooding, congestion, snow accumulation, or the like has occurred by analyzing the acquired moving image.

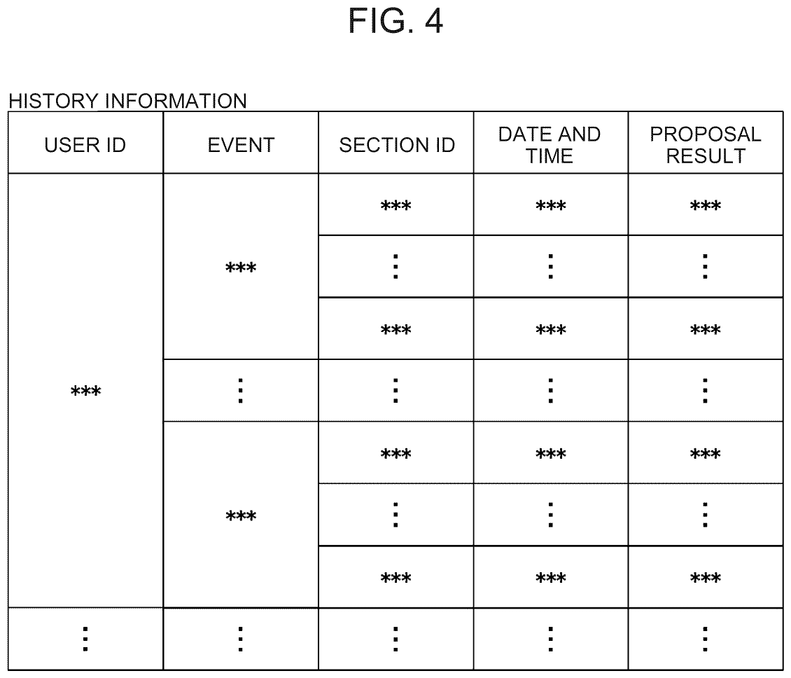

The history information DB 204 has a function of holding history information. The history information is information indicating a history of acceptance of the user of the vehicle 10 with respect to the proposal of the bypass in the past. The history information DB 204 can be realized by the auxiliary storage unit 230 in the server 200. FIG. 4 is a diagram illustrating an exemplary table configuration of the history information held in the history information DB 204. As illustrated in FIG. 4, the history data includes a user ID field, an event field, a section ID field, a date and time ID field, and a suggestion outcome field.

In the user ID field, an identifier (user ID) for identifying a user is stored. In the event field, information indicating an event causing a recommended bypass of the section for the user of the corresponding user ID is stored. In the event field, information indicating a stop of passage, flood, traffic jam, snow accumulation, or the like of a part or all of the section is stored. In the section ID field, an identifier (section ID) for identifying a section in which bypassing is proposed due to a corresponding event is stored. In the date and time information, information indicating the date and time at which the proposal for the bypassing of the corresponding section is made in the past is stored. In the proposal result field, information indicating whether the user has accepted the proposal is stored after the proposal of the bypass is made due to the corresponding event in the past.

As described above, in the history information, the section ID, the information indicating the date and time when the bypass proposal was made, and the information indicating the outcome of the bypass proposal are stored for each event. The control unit 201 acquires the history information held in the history information DB 204, and thereby can recognize the acceptance of the user of the vehicle with respect to the proposal of the bypass in the past.

By acquiring the road information stored in the road information DB 203, the control unit 201 can determine whether a bypass recommendation section exists on the scheduled travel route of the vehicle 10 in the route information. Specifically, the control unit 201 acquires the section ID of the sections included in the scheduled traveling route. The control unit 201 determines whether there is a section in which bypassing is recommended by referring to the bypass field of the section corresponding to the section ID corresponding to the section ID acquired from the route information among the section IDs of the sections in the road information.

The control unit 201 acquires the history information from the history information DB 204 when it is determined that the bypass recommendation section exists on the scheduled traveling route of the vehicle 10. The control unit 201 refers to the information of the proposal result field in the acquired history information, and calculates the acceptance rate of the user of the vehicle 10. Specifically, the control unit 201 refers to the information of the proposal result field in the history information, and calculates the acceptance rate by dividing the number of times that the user of the vehicle 10 accepts the proposal of the bypass of the section by the number of times that the proposal of the bypass of the section has been made in the past. Then, the control unit 201 calculates whether the acceptance rate of the user of the vehicle 10 is equal to or greater than the threshold value.

At this time, it is assumed that the acceptance rate of the user of the vehicle 10 is different for each event that is the cause of the recommended bypassing. For example, a studless tire may be mounted on the vehicle 10. In this case, the user of the vehicle 10 may not need to bypass even in a snowy section. On the other hand, the user of the vehicle 10 may accept a bypass proposal in a case where an event other than snow cover (for example, a traffic jam) occurs. In this way, it is assumed that the acceptance rate of the user of the vehicle 10 differs for each event that caused the recommended bypassing. Therefore, the control unit 201 acquires, from the event field in the road information held in the road information DB 203, information indicating the event causing the bypassing to be recommended in the bypass recommendation section. Then, the control unit 201 refers to the history information held in the history information DB 204, and calculates the acceptance rate for the event causing the bypass to be recommended in the bypass recommendation section. That is, in a case where the event causing the recommended bypassing in the bypass recommendation section is, for example, snow accumulation, the control unit 201 calculates the acceptance rate when the bypassing of the section is recommended in the past due to snow accumulation.

When the acceptance rate of the user of the vehicle 10 is equal to or greater than the threshold value, the control unit 201 outputs the proposal information. Thus, the proposal information is output when the acceptance rate of the event causing the recommended bypassing in the bypass recommendation section is equal to or greater than the threshold value.

In addition, when the entrustment rate of the user of the vehicle 10 is less than the threshold value, the control unit 201 acquires load information. Here, the load information is information indicating a load state of driving of the user of the vehicle 10. Here, in a case where the vehicle 10 is traveling on a road having a large curve, it is assumed that the load of driving by the user is higher than in a case where the vehicle is traveling on a road having a small curve. Therefore, in the present embodiment, the load information is indicated by the number of curves existing within a predetermined range from the current position of the vehicle 10 and existing on the route on which the vehicle 10 has traveled and on the scheduled traveling route.

The control unit 201 calculates the load situation of the user's driving of the vehicle 10 from the planned travel route in the route information and the current position of the vehicle 10. Specifically, the control unit 201 acquires the number of curves existing within a predetermined range from the current position of the vehicle 10 and existing on the scheduled traveling route. The control unit 201 acquires the number of curves by referring to the map information. Then, when the number of acquired curves is equal to or greater than a predetermined number, the control unit 201 determines that the driving load of the user of the vehicle 10 is high (high load state). When the number of acquired curves is less than the predetermined number, the control unit 201 determines that the driving load of the user of the vehicle 10 is low.

Here, it is assumed that the user under the high load condition concentrates on driving. At this time, if an unnecessary bypassing is proposed to a user who does not need a bypass proposal, it is assumed that the user feels troublesome. On the other hand, it is assumed that even a user who does not require a bypass proposal does not feel troublesome even if a bypass proposal is made unless the user is in a high-load state. Therefore, when the entrustment rate of the user of the vehicle 10 is less than the threshold value, the control unit 201 refers to the load information and determines whether the user of the vehicle 10 is in the high load state. When the user of the vehicle 10 is under a high load condition, the control unit 201 does not output the proposal information because it is assumed that the user feels troublesome. In addition, when the user of the vehicle 10 is not in the high load state, the control unit 201 outputs the proposal information to the in-vehicle device 100 because it is assumed that the user does not feel troublesome.

After outputting the proposal information to the in-vehicle device 100, the control unit 201 determines whether the user of the vehicle 10 has accepted the bypass proposal. Specifically, the control unit 201 refers to the current position of the vehicle 10 and determines whether the vehicle 10 has traveled in the bypass recommendation section. Here, the control unit 201 receives the present position of the vehicle 10 acquired by GPS device in the vehicle 10 from the in-vehicle device 100 in real time.

When the current position is not on the bypassing recommendation section until the vehicle 10 reaches the destination, the control unit 201 determines that the user of the vehicle 10 has accepted the bypass proposal. Further, when the current position of the vehicle 10 is on the bypassing recommendation section, the control unit 201 determines that the user of the vehicle 10 has not accepted the bypass proposal. The control unit 201 records the acceptance of the bypass by the user of the vehicle 10 in the history information held in the history information DB 204. In this way, the history information is updated. As a result, the control unit 201 can grasp the latest data regarding the acceptance result (acceptance rate) of the user.

### First Process

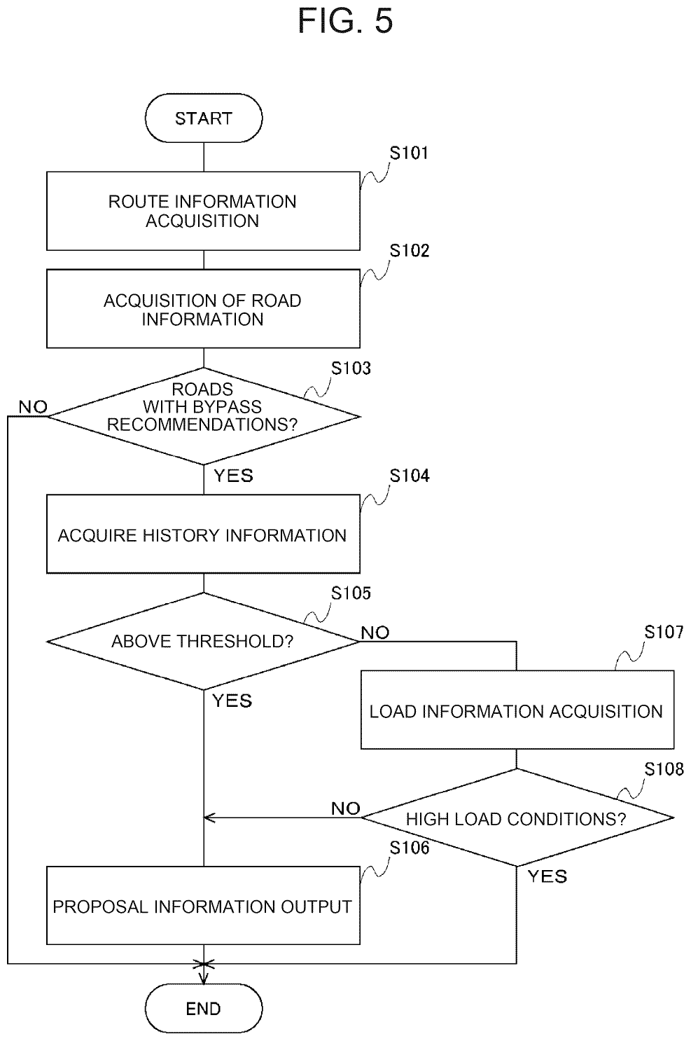

Next, a first process executed by the control unit 201 in the server 200 in the proposal system 1 will be described with reference to FIG. 5. FIG. 5 is a flowchart of the first process. The first process illustrated in FIG. 5 is a process of outputting the proposal information. The first process is repeatedly executed at predetermined intervals after the route information is transmitted to the in-vehicle device 100.

In the first process, first, in S101, route data transmitted to the in-vehicle device 100 is acquired. Next, in S102, road information is obtained from the road information DB 203. Next, in S103, the bypass field in the acquired roadway information is referred to, and it is determined whether a bypass recommendation section exists. Next, the history information is acquired from the history information DB 204 in S104. Next, in S105, a determination is made as to whether the acceptance rate is greater than or equal to the thresholds. At this time, it is determined whether the acceptance rate of the event causing the recommended bypassing in the bypassing recommendation section is equal to or greater than the threshold value.

When an affirmative determination is made in S105, it is assumed that the user of the vehicle 10 is highly required to propose bypassing. Therefore, when an affirmative determination is made in S105, the proposal information is output to the in-vehicle device 100 in S106. As a result, the in-vehicle device 100 outputs to the user of the vehicle 10 a proposal to bypass the bypass recommendation section. Accordingly, it is possible to make a bypass proposal to a user who needs a bypass proposal. Then, the first process is terminated once.

When a negative determination is made in S105, the load information is acquired in S107. Next, in S108, it is determined whether the user of the vehicle 10 is in a high-load condition. Specifically, the load information is referred to, and it is determined whether the number of curves on the scheduled traveling route within a predetermined range from the current position of the vehicle 10 is equal to or greater than a predetermined number. When an affirmative determination is made in S108, the user of the vehicle 10 is under a high-load condition, and therefore, when the in-vehicle device 100 outputs the proposal information, it is assumed that the user of the vehicle 10 feels troublesome. Therefore, when an affirmative determination is made in S108, the first process is temporarily terminated without outputting the proposal information to the in-vehicle device 100.

In addition, when a negative determination is made in S108, the user of the vehicle 10 is not in a high-load state, and thus it is assumed that the vehicle 10 has a mental margin. Therefore, even if the in-vehicle device 100 outputs the proposal information, it is assumed that the user of the vehicle 10 does not feel troublesome. Therefore, when a negative determination is made in S108, the proposal information is output (transmitted) to the in-vehicle device 100 in S106. As a result, the in-vehicle device 100 outputs to the user of the vehicle 10 a proposal to bypass the bypass recommendation section. Then, the first process is terminated once.

Further, the first process is repeatedly executed at predetermined intervals after the route information is transmitted to the in-vehicle device 100. In addition, the road-information is updated by acquiring the presence or absence of the recommendation of the bypassing in the section ID in real time. That is, when an event that recommends a new bypass occurs, information about the event is included in the road information. Therefore, by repeatedly acquiring the road information, it is possible to determine whether to output the proposal information even when an event that recommends new bypassing occurs. Second Process

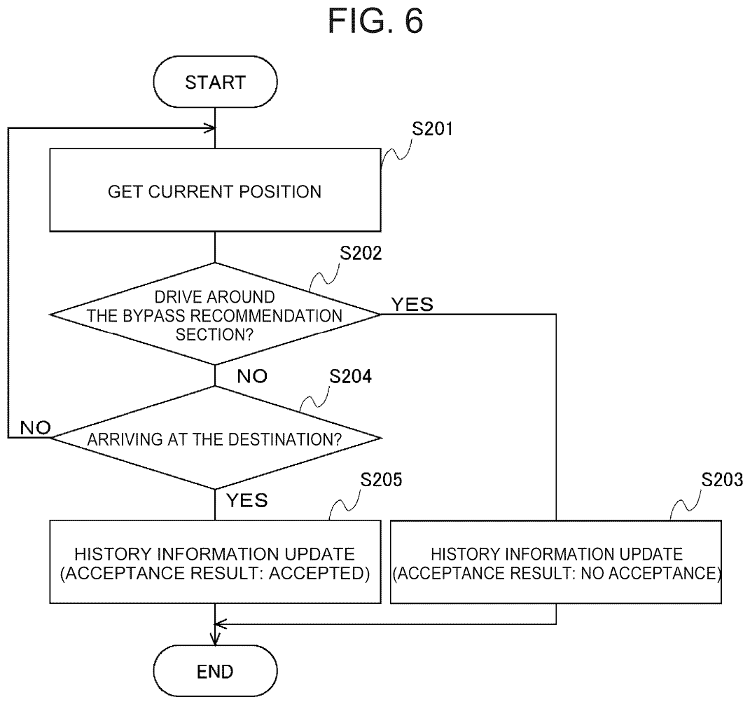

Next, a second process executed by the control unit 201 in the server 200 in the proposal system 1 will be described with reference to FIG. 6. FIG. 6 is a flowchart of a second process. The second process illustrated in FIG. 6 is a process of updating the history information. The second process is executed after the proposal information is output to the in-vehicle device 100.

In the second process, first, in S201, the present position of the vehicle 10 received from the in-vehicle device 100 is acquired. Next, in S202, the present position of the vehicle 10 is referred to, and it is determined whether the vehicle 10 is traveling in the bypass recommendation section. That is, it is determined whether the current position of the vehicle 10 is on the bypass recommendation section.

When an affirmative determination is made in S202, it can be determined that the user of the vehicle 10 does not accept the suggestion of the bypassing because the vehicle 10 is traveling in the bypassing recommendation section. Therefore, when an affirmative determination is made in S202, the history information held in the history information DB 204 is updated in S203. At this time, information indicating that the user of the vehicle 10 has not accepted the bypass proposal is added to the history information. Then, the second process is ended.

When a negative determination is made in S202, the user of the vehicle 10 does not travel in the bypass recommendation section at the time of the determination. However, the user of the vehicle 10 may then travel through the bypassing recommendation section. Therefore, when a negative determination is made in S202, it is determined whether the vehicle 10 has arrived at the destination in S204. Specifically, the destination of the vehicle 10 included in the destination information is referred to, and it is determined whether the vehicle 10 has arrived at the destination.

If a negative determination is made in S204, the vehicle 10 has not arrived at the destination. Therefore, the present position of the vehicle 10 is acquired again in S201. At this time, since the current position of the vehicle 10 is received in real time, the obtained current position of the vehicle 10 is the current position of the latest vehicle 10. Then, S202 process is performed by referring to the present position of the latest vehicle 10. In addition, S203 and S204 processes are executed according to S202 determination. In this way, S201 and S202 processes are repeatedly performed until the vehicle 10 arrive at the destination.

In S204, when an affirmative determination is made, the vehicle 10 has arrived at the destination without traveling in the bypassing recommendation section. Therefore, it can be determined that the user of the vehicle 10 has accepted the bypass proposal. Therefore, in S205, the history information held in the history information DB 204 is updated. At this time, information indicating that the user of the vehicle 10 has accepted the bypass proposal is added to the history information. Then, the second process is ended.

In the present embodiment, the control unit 201 determines whether the user of the vehicle 10 has accepted the proposal of the bypassing by determining whether the bypass recommendation section has been traveled until the vehicle 10 arrives at the destination. However, it may be determined by other methods whether the user of the vehicle 10 has accepted the bypass proposal. For example, the control unit 201 may receive, from the in-vehicle device 100, information indicating an answer to a bypass proposal made by the user of the vehicle 10. In this case, the user of the vehicle 10 inputs an answer to the bypass proposal to the in-vehicle device 100, and information indicating an answer to the bypass proposal by the user of the vehicle 10 is transmitted to the server 200.

As described above, the proposal system 1 outputs the proposal information according to the acceptance rate. Accordingly, it is possible to propose bypassing of the bypass recommendation section according to the necessity of the bypass proposal which can be assumed from the acceptance rate. At this time, the acceptance rate of the event causing the recommended bypassing in the bypass recommendation section is acquired. As a result, in a case where it is not necessary to propose bypassing associated with an event that causes the bypassing to be recommended in the bypassing recommendation section, the output of the proposal information is suppressed. Further, since the acceptance rate is lower than the threshold value, even when it is assumed that the user of the vehicle 10 does not need to propose bypassing, the possibility of outputting the proposal information is determined according to the load of driving of the vehicle 10. This suppresses the output of the proposal information by the in-vehicle device 100 when there is no mental margin in the driving vehicle 10. In this way, it is possible to make a bypass proposal so that the user does not feel troublesomeness.

### First Modification

In the present embodiment, the proposal information is not output to the in-vehicle device 100 when the acceptance rate is less than the threshold value and the user of the vehicle 10 is in the high load state. However, the proposal information may be output when the acceptance rate is equal to or greater than the threshold, and may not be output when the acceptance rate is less than the threshold. That is, when a negative determination is made in S105 when the first process is executed, S107 and S108 processes may not be performed. In this case, when a negative determination is made in S105, the first process is terminated without outputting the proposal information. Even in this manner, it is possible to propose bypassing so that the user of the vehicle 10 does not feel troublesomeness.

### Second Modification

Further, the server 200 may change the method of outputting the proposal information in the in-vehicle device 100 in accordance with the acceptance rate. Here, if a large amount of information is provided to the user of the vehicle 10, it is assumed that the user of the vehicle 10 feels troublesome. Therefore, the server 200 changes the amount of information to be provided to the user of the vehicle 10 in accordance with the acceptance rate, thereby changing the method of outputting the proposal information in the in-vehicle device 100.

Specifically, when the acceptance rate is equal to or higher than the threshold value, proposal information for making a bypass proposal using sound and display may be output. In this case, the proposal information includes, for example, data for outputting sound suggesting bypassing, and data for displaying a bypass proposal on a display of the in-vehicle device 100. The in-vehicle device 100 uses the data to output and display a sound for making a bypass proposal to the user of the vehicle 10.

Specifically, the in-vehicle device 100 that has received the proposal information outputs a sound that makes a bypass proposal by a speaker, thereby proposing bypassing using the sound. In addition, the in-vehicle device 100 that has received the proposal information, for example, superimposes the position of the bypassing recommendation section on the map displayed by the navigation system, thereby making a bypass proposal using the display.

Further, when the acceptance rate is less than the threshold value, the proposal information for making the proposal of the bypass using the sound may be output without making the proposal of the bypass by the display. In this case, the proposal information does not include data for displaying a bypass proposal on the display of the in-vehicle device 100, but includes data for outputting a sound for proposing bypassing. The in-vehicle device 100 uses data to output sounds that suggest bypassing, and outputs sounds that suggest bypassing to the vehicle 10.

As described above, in the present modification example, the method of outputting the proposal information in the in-vehicle device 100 is determined according to the acceptance rate as to which of the proposal of the bypassing by the sound and the display and the proposal of the bypassing by the sound is proposed. At this time, when the user of the vehicle 10 needs to make a bypass proposal, the bypass proposal is made by sound and display, so that a more detailed bypass proposal can be made to the user.

In addition, when the user of the vehicle 10 does not need to propose bypassing, when the position of the bypassing recommendation section is superimposed on the map displayed by the navigation system, it is assumed that the user feels troublesome. On the other hand, if only the sound-based bypass proposal is made, the amount of information provided to the user of the vehicle 10 is smaller than in the case where the display-based bypass proposal is also made. Therefore, the troublesomeness felt by the user of the vehicle 10 can be suppressed. In this way, it is possible to make a bypass proposal so that the user does not feel troublesomeness.

### Third Modification

In the present embodiment, the load information is indicated by the number of curves existing within a predetermined range from the current position of the vehicle 10 and existing on the route on which the vehicle 10 has traveled and on the scheduled traveling route. However, the load information may be information indicated by other information. For example, in a case where the car navigation system (the in-vehicle device 100) in the vehicle 10 frequently performs navigation, the user of the vehicle 10 concentrates on driving, and therefore, it is assumed that the vehicle is under a high load condition. Therefore, the load information may be information indicated by the timing of navigation by the in-vehicle device 100.

The server 200 acquires the load information by, for example, referring to the scheduled travel route of the vehicle 10 and predicting the timing at which the in-vehicle device 100 performs navigation. Then, the server 200 determines that the in-vehicle device 100 is not in a high-load state at a timing at which navigation is not performed for a predetermined time or longer.

Before the departure of the vehicle 10, the user of the vehicle 10 does not start driving, and therefore it is assumed that the vehicle is not in a high-load state. Further, if the vehicle 10 is before departure, it is assumed that the user of the vehicle 10 is likely to accept a change in the route caused by bypassing the bypass recommendation section. On the other hand, if the vehicle 10 is after departure, since the user of the vehicle 10 is driving, it is assumed that the vehicle is under a high load condition. Further, after the vehicle 10 has departed, since it has already decided to travel along the scheduled travel route, it may be difficult to accept the change of the route associated with the bypass recommendation section. Therefore, the load information may be information on whether the vehicle 10 has started.

In this case, the server 200 receives the load information from the in-vehicle device 100. The load information is, for example, information on the travel history of the vehicle 10, information on the timing of ON and OFF of the ignition switch of the vehicle 10, or information on the travel schedule of the vehicle 10. The server 200 refers to the load information and determines whether the vehicle 10 is in a high-load state by determining whether the vehicle 10 is in a state before departure. That is, when the vehicle 10 is not before departure, the server 200 determines that the vehicle is under a high load condition. When the vehicle 10 is before departure, the server 200 determines that the vehicle is not in a high load state.

When the acceptance rate is less than the threshold value and the vehicle 10 is not before departure, the server 200 does not output the proposal information to the in-vehicle device 100. When the acceptance rate is less than the threshold value and the vehicle 10 is before departure, the server 200 outputs the proposal information to the in-vehicle device 100. Even in this manner, it is possible to propose bypassing so that the user of the vehicle 10 does not feel troublesomeness.

### Fourth Modification

In the present embodiment, the first process is repeatedly executed at predetermined intervals after the route information is transmitted to the in-vehicle device 100. That is, in the first process, when the bypass recommendation section exists on the scheduled traveling route of the vehicle 10, it is determined whether to output the proposal information. On the other hand, in the present modification, the server 200 determines whether to output the proposal information without acquiring the scheduled traveling route of the vehicle 10. Specifically, the server 200 determines whether a bypass recommendation section exists within a predetermined range from the current position of the vehicle 10. Here, the predetermined range is defined as a range in which the vehicle 10 may travel within a predetermined time. Then, when a bypass recommendation section exists within a predetermined range from the current position of the vehicle 10, a determination is made as to whether the acceptance rate is equal to or greater than a threshold value, and whether the proposal information can be output is determined. Even in this manner, it is possible to propose bypassing so that the user of the vehicle 10 does not feel troublesomeness.

### Fifth Modification

The server 200 may reset the history information of the user of the vehicle 10 held in the history information DB 204 at predetermined timings. Here, the predetermined timing is a timing at which the user of the vehicle 10 instructs to reset the history information. The predetermined timing may be a timing at which a certain period of time has arrived.

At this time, the server 200 may delete, from the history information of the user of the vehicle 10, the history information in the period before the predetermined time. Further, the control unit 201 may reset all the history information of the user of the vehicle 10. In this case, the control unit 201 transmits the proposal information to the in-vehicle device 100 regardless of the acceptance rate for a predetermined period after resetting the history information. As a result, data for recalculating the acceptance rate during a predetermined period of time can be collected. Further, even in a case where the necessity of the bypass proposal for the user of the vehicle 10 changes with the passage of time, the bypass proposal can be made so that the user of the vehicle 10 does not feel troublesome.

### Other Embodiments

The above-described embodiments are mere examples, and the present disclosure can be implemented with appropriate modifications within a range not departing from the scope thereof. Moreover, the processes and units described in the present disclosure can be freely combined and implemented unless technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. A non-transitory computer-readable storage medium may include any type of disk, such as, for example, a magnetic disk (such as a floppy disk or a hard disk drive (HDD)), an optical disk (such as a CD-ROM, DVD disk or a Blu-ray disk). Non-transitory computer-readable storage media may also include any type of media suitable for storing electronic instructions, such as read only memory (ROM), random access memory (RAM), EPROM, EEPROM, magnetic cards, flash memory, or optical cards.

What is claimed is:

1. An information processing device comprising a control unit that is configured to execute:
acquiring an acceptance rate of a user of a vehicle in response to past bypass proposals when there is a bypass recommendation section in which bypassing is recommended on a route of the vehicle; and
outputting proposal information for proposing to bypass the bypass recommendation section in accordance with the acceptance rate.

2. The information processing device according to claim 1, wherein the acquiring of the acceptance rate includes acquiring an acceptance rate when bypassing has been proposed for the user in a past due to the same reason for the bypassing as a reason of recommending the bypassing of the bypass recommendation section.

3. The information processing device according to claim 1, wherein:
the control unit is configured to further execute acquiring load information regarding a load of driving on the user; and
the outputting of the proposal information in accordance with the acceptance rate includes outputting the proposal information in accordance with the acceptance rate and the load information.

4. The information processing device according to claim 1, wherein the outputting of the proposal information includes
outputting proposal information for proposing bypassing using sound and display when the acceptance rate is equal to or greater than a threshold value, and
outputting proposal information for proposing bypassing using sound without proposing bypassing using display when the acceptance rate is less than the threshold value.

5. The information processing device according to claim 1, wherein the outputting of the proposal information includes:
outputting the proposal information when the acceptance rate is equal to or greater than a threshold value; and
when the acceptance rate is less than the threshold value,
determining whether the vehicle is before departure,
outputting the proposal information when the vehicle is before departure, and
omitting the outputting of the proposal information when the vehicle is not before departure.
